(19) United States
(12) Patent Application Publication
(10) Pub. No.: US 2016/0156605 A1
(43) Pub. Date: Jun. 2, 2016

(54) A METHOD FOR RETRIEVING INTERNET AUTHENTICATION INFORMATION AND MEANS THEREOF

(71) Applicant: BEIJING GEEK-GEEK TECHNOLOGY CO., LTD., Beijing (CN)

(72) Inventor: YONGMING YANG, Beijing (CN)

(21) Appl. No.: 14/902,845

(22) PCT Filed: Mar. 2, 2015
(86) PCT No.: PCT/CN2015/073476

§ 371 Date: Jan. 4, 2016

(30) Foreign Application Priority Data
Mar. 19, 2014 (CN) 201410103074.8

(51) Int. Cl. H04L 29/06; H04L 29/08

(52) U.S. Cl. CPC H04L 63/08; H04L 67/2819; H04L 63/1408

(57) ABSTRACT

The invention presented relates to the field of network communication, and disclosed a method and means for retrieving Internet authentication information technically. This method comprises: connect the original functioning network device and receive the packets sent by it; extract the communication data sent to the ISP from those packets, and analyze it to figure out the authentication information needed to access the Internet; record that authentication information, and use or display it whenever adequate. The invention presented can help users retrieve the required authentication information without the need for help from ISPs, which can be very convenient for users who forgot his authentication information when trying to access the Internet or to replace the old network device with the new one.

### FIELD OF THE INVENTION

The invention presented relates to the field of network communication technology, and particularly, relates to a method and means for retrieving Internet authentication information from the ISP technically.

### BACKGROUND OF THE INVENTION

Modern computer networks, based on the size and range of connected devices, are usually divided into local area networks, wide area networks, etc. Generally, LANs can be set up freely by an ordinary user, while for those who want to access a larger network (e.g., Internet), services provided by Internet Service Providers (ISP) are required. To guarantee quality and revenue of their service, ISPs usually provide their users with independent authentication information. Users are asked to get themselves authenticated during the connection establishment period before he could enjoy accessing the Internet.

The authentication information is usually a random combination of letters and digits. It is hard to remember as a lack of relevance. Moreover, as it is rarely needed to remember in our everyday life, people just don't keep it carefully. Even if users took notes and kept it somewhere, it is not easy to find it after a long time. Thus it often happens that users lose the notes and forget their authentication information. Take ADSL dial-up for example, most commonly, username and password are required to fill into some pre-defined location of the dial-up program running on the computer or the router in the first use. Afterwards, users can access the Internet directly without the need to re-input the account information. So the account information is easily forgotten after a long time.

When it comes to replacing the old router with a new one, or if the software settings of the dial-up program were deleted/reset, users need to get themselves re-authenticated. Once users forget the required authentication information, they have trouble in normal Internet access. With Internet access unavailable, such problems can only be solved off-line. Users would have to contact their ISPs to reacquire their account information. The procedures are complicated and of low efficiency. Users are asked to submit all kinds of certification information. Sometimes, they need to go to the business hall themselves, which is time-consuming and is certainly a bad experience. However, without such certification procedure, the safety of the users' account can't be guaranteed. Things are even worse for those who have no idea of turning to their ISPs for help.

### DETAILS OF THE INVENTION

To address the issues stated above, the technical problem this invention wants to resolve is, how to retrieve the Internet authentication information intelligently, without the need for help from ISPs.

To address this problem, on one hand, this invention provides a method for retrieving Internet authentication information, including the following steps:

Connect the original functioning network device and receive the data packets sent by it.

Extract the communication data from those packets sent to the ISP, and analyze it to figure out the authentication information needed to access the Internet.

Record that authentication information, and use or display it whenever adequate.

Preferably, in the said method, connecting the original functioning network device is in detail:
an upper device, connected to the network interface of the original network device, communicates with the original device, simulating the behavior of the server program of the ISP.

Preferably, in the said method, connecting the original functioning network devices in detail:
a network relay device, connected between the original network device and the dialing device, transmits and monitors all the data packets sent and received by the original network device.

Preferably, in the said method, using the said authentication information whenever adequate is in detail:
when users connect their new network devices with the Internet and try to access the Internet, the invention will fill the authentication information into some proper location of the dial-up program for it to run on behalf of users.

Preferably, in the said method, displaying the said authentication information whenever adequate is in detail:
when a user wants to know the content of his authentication information, displaying the clear text of the said authentication information to him.

On the other hand, meanwhile, the invention presented provides a means for retrieving Internet authentication information, including:
a receipt module for connecting the original functioning network device and receiving the data packets sent by the said original network device;
an analyzing module for extracting communication data from the data packets sent to the ISP, and analyzing it to figure out the authentication information needed to access the Internet.
a recording module for recording the said authentication information, and using or displaying it whenever adequate.

Preferably, the said receipt module also includes:
a simulating module , serves as an upper device, connected with the network interface of the original network device, communicates with the original device simulating the behavior of the server program of the ISP.

Preferably, the said receipt module also includes:
a relay and monitor module, serves as the network relay device, is connected between the original network device and the dial-up device , transmitting and monitoring all the data packets sent and received by the original network device.

Preferably, the said means is a new network device to take place of the old one.

Preferably, the said means is a router device .

Compared to existing technologies hitherto, the invention presented provides a method and means for retrieving Internet authentication information without the need for help from ISPs, which can be very convenient for users who forgot his authentication information when trying to access the Internet or to replace the old network device with the new one.

### BRIEF ILLUSTRATION OF THE FIGURES

FIG. 1 is the flow chart of a means for retrieving Internet authentication information according to an embodiment of the present invention;

FIG. 2 is a schematic diagram of how the devices connect and communicate according to one preferable embodiment of the present invention;

FIG. 3 is a schematic diagram of how the devices connect and communicate according to another preferable embodiment of the present invention.

### DETAILED DESCRIPTION OF THE PREFERRED EMBODIMENTS

Hereinafter, the technical solution in the preferable embodiments of the present invention will be described as clearly and completely as possible, with reference to the figures in the embodiments mentioned above of the present invention. Apparently, the embodiments described here are just a few of all possible preferable embodiments of the present invention. The description here is intended for explaining the basic principle of the present invention, not for limiting the scope of the present invention. The scope of the present invention should be based on that defined by the claims. All the other embodiments, which are based on embodiments in the present invention and achieved by a skilled person in the field without innovative contribution, should belong to the scope of the present invention.

Usually, the users who need to get authenticated to access the Internet (e.g., an ADSL user), access the Internet through the wide-spread technology of PPPoE (Point to Point Protocol Over Ethernet). The common procedure of Internet access over PPPoE is: the PPPoE client sends the username and password to an PPPoE server of the ISP on behalf of the user. On receipt of the account information, the PPPoE server checks to verify the validation of the account information before granting its user Internet access. After that, users generally forgot that account information, as the dial-up program encrypted and saved that information for the users' sake. Sometimes later when users need to re-input the authentication information that they have forgot and even don't know where to find it, the only thing they could do would turn to the ISP for help, or else, they would have to put up with it. Neither way would be a good choice and will certainly bring great distress.

In the present invention, the new device retrieves the user's Internet authentication information by collecting and analyzing data packets send to ISP from the original functioning network device automatically, after which the authentication information can be extracted, thus helps the user with his Internet access when he needs to replace his network device but unfortunately forgets the account information.

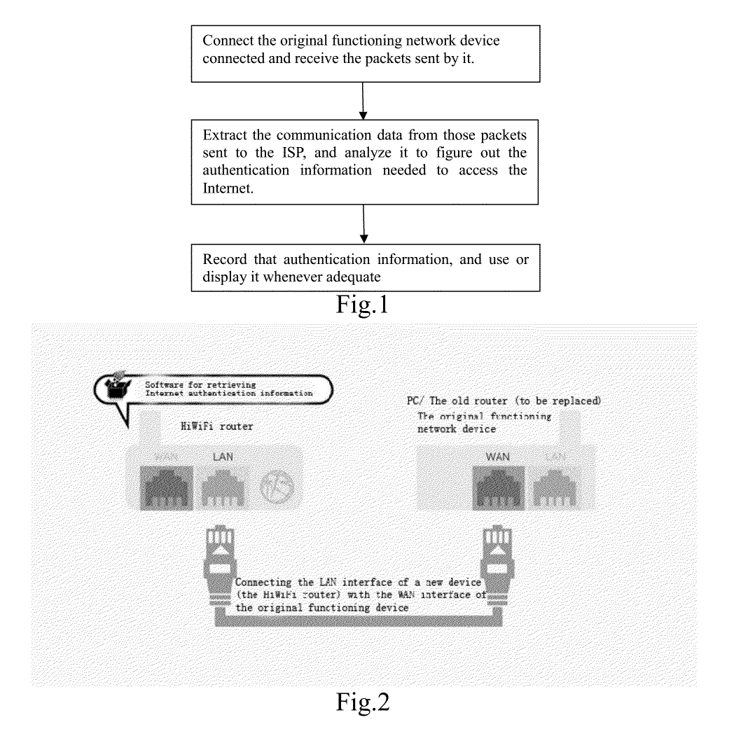

As shown in FIG. 1, a method for retrieving Internet authentication information in one embodiment of the present invention, including the following steps:

Connect the original functioning network device connected and receive the packets sent by it.

Extract the communication data from those packets sent to the ISP, and analyze it to figure out the authentication information needed to access the Internet.

Record that authentication information, and use or display it whenever adequate.

A skilled person in this field should be able to understand that all or part of the steps in the method above can be done by relevant hardware instructions performed by a program. The said program can be stored in a storage medium readable by computer. Whenever this program is executed, every step of the above method will be performed. And the said storage medium can be ROM/RAM, diskette, compact disc, memory card, etc. Therefore, the relevant skilled person in this field should be able to understand that, corresponding to the method of the present invention, the present invention also provides a means for retrieving Internet authentication information. With
a one-to-one correspondence to the steps of the above method the said means including:
a receipt module for connecting the original functioning network device and receiving the data packet sent by the said original network device;
an analyzing module for extracting communication data from the packets sent to the ISP, and analyzing it to figure out the authentication information needed to access the Internet;
a recording module for recording the said authentication information, and using or displaying it whenever adequate.

The preferable means mentioned above is a new network device; More preferably, a router device.

In the more preferable embodiments of the present invention, there are two typical ways to connect the original network device and receive data packets sent from it. One is to simulate the server of the ISP to communicate with the original network device directly. The other is to monitor packet flow as a relay device when transmitting data packets sent from the original network device to the server of the ISP.

More specifically, in the first typical preferable embodiment, as shown as FIG. 2, the way for connecting the original network device is, a network interface(preferably the LAN interface) of the new network device is connected with a network interface (preferably the WAN interface) of the original functioning network device via Ethernet cable. Subsequently, the new network device simulates the behavior of the server program of the ISP to communicate with the original network device, and receives data packets (with authentication information in it) sent by the original network device. By analyzing data packets based on pre-defined forms of the server program of the ISP, authentication information can be retrieved. A skilled person in this field should be able to understand that the way for connecting LAN interface of the new device (HiWiFi router) with WAN interface of the original device as shown as FIG. 2 is just one of the most preferable ways possible. As long as data packets could be received effectively from the original device, any cable and/or wireless interface can be used to connect the two devices in the present invention. For example, if the original device is a PC, as an alternative embodiment, the LAN(WiFi) interface of a HiWiFi router can be connected to by the corresponding LAN(WiFi) interface of the PC. Thus, herein the way of connecting the two devices should not be a limiting factor to the present invention.

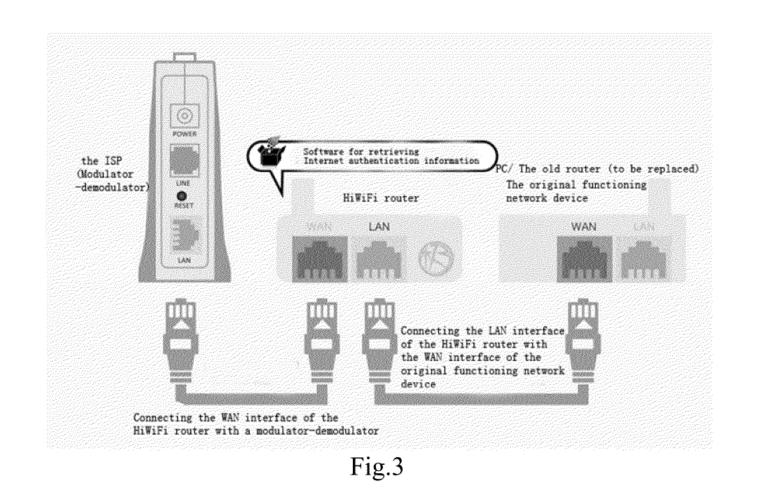

In the second typical preferable embodiment, as shown as FIG. 3, the way for connecting the original network device is, a network interface (preferably the WAN interface) of the original network device is connected with a network interface (preferably the LAN interface) of the new network device via Ethernet cable. Then a network interface (preferably the WAN interface) of the new network device is connected with a dialing device (preferably a modulator-demodulator) of the ISP, via Ethernet cable too. Thereafter, as the network relay device, the new network device transmits all the data packets sent and received by the original network device, and meanwhile, monitors and recognizes communication data (with authentication information in it) sent to ISP by the original network device. By analyzing the data packets based on the pre-defined forms, authentication information can be retrieved. In the same way, a skilled person in this field should be able to understand that the way that the new equipment (HiWiFi router) connects the original device with a dialing device as shown as FIG. 3 is only one of the most preferable ways possible. As long as data packets can be transmitted effectively from the original device to the dialing device, any cable and/or wireless interface can be used to connect several equipments in the present invention. For example, a HiWiFi router can connect to the dialing -up device by the LAN interface, or as an alternative embodiment a HiWiFi router can be connected with the LAN(WiFi) interface of the original device (a router or PC) by the corresponding LAN(WiFi) interface. Thus, herein the way of connecting several devices should not be a limiting factor to the present invention.

No matter which embodiment is taken, the new network device first records the retrieved authentication information somewhere locally. It can be recorded either in clear text or encrypted. Whenever users need to access the Internet using the new network device, the embodiment will fill in the authentication information at some pre-defined location of the dial-up program on behalf of them, after which users can enjoy their normal Internet access. Or, if the user wants to know the content of his authentication information, the embodiment will display the clear text of the said authentication information to him.

Compared to existing technologies hitherto, the present invention provides a method and means for retrieving Internet authentication information, without the need for help from ISPs, which can be very convenient for users who forgot his authentication information when trying to access the Internet or to replace the old network device with the new one.

Compared with existing programs that require complicated certification procedures, it takes only less than 1 minute to retrieve authentication information, which is certainly convenient for users, enhancing their experience and saving their time and effort greatly.

The embodiments mentioned above are just a few preferable embodiments of the present invention, and it should be noted that the preferable embodiments mentioned above don't form a limiting factor of the present invention. The scope of the present invention should be based on that defined by the claims. For a skilled person in this field, without departing from the spirit and scope of the present invention, any improvement and amendment can be made, and these improvement and amendment should belong to the scope of the present invention.

1. A method for retrieving Internet authentication information, characterized in that, including the steps:
connect the original functioning network device and receive the packets sent by it; extract the communication data sent to the ISP from those packets, and analyze it to figure out the authentication information needed to access the Internet; record that authentication information, and use or display it whenever adequate.

2. The method according to the claim 1, characterized in that, in the said method, connecting the original functioning network device is in detail:
an upper device, connected to the network interface of the original network device, communicates with the original device simulating the behavior of the server program of the ISP.

3. The method according to the claim 1, characterized in that, in the said method, connecting the original functioning network device is in detail:
a network relay device, connected between the original network device and the dialing device, transmits and monitors all the data packets sent and received by the original network device.

4. The method according to the claim 1, characterized in that, in the said method, using the said authentication information whenever adequate is in detail:
when users connect their new network devices with the Internet and try to access the Internet, the invention will fill the authentication information into some proper location of the dial-up program for it to run on behalf of users.

5. The method according to the claim 1, characterized in that, in the said method, displaying the said authentication information whenever adequate is in detail:
when the user wants to know the content of his authentication information, displaying the clear text of the said authentication information to him.

6. A means for retrieving Internet authentication information, characterized in that, the said means including:
a receipt module for connecting the original functioning network device , and receiving the data packets sent by the said original network device;
an analyzing module for extracting communication data from the packets sent to the ISP, and analyzing it to figure out the authentication information needed to access the Internet;
a recording module for recording the said authentication information, and using or displaying it whenever adequate.

7. The means according to the claim 6, characterized in that, the said receipt module also includes:
a simulating module, serves as an upper device, connected with the network interface of the original network device, communicates with the original device simulating the behavior of the server program of the ISP.

8. The means according to the claim 6, characterized in that, the said receipt module also includes:
a relay and monitor module, serves as the network relay device, is connected between the original network device and the dial-up device, transmitting and monitoring all the data packets sent and received by the original network device.

9. The means according to the claim 6, characterized in that, the said means is a new network device to take place of the old one.

10. The means according to the claim 6, characterized in that, the said means is a router device.

11. The means according to the claim 9, characterized in that, the said means is a router device.
